(19) United States
(12) Patent Application Publication
(10) Pub. No.: US 2005/0269447 A1
(43) Pub. Date: Dec. 8, 2005

(54) Ornithopter with independently controlled wings

(76) Inventor: Nathan Jeffrey Chronister, Rochester, NY (US)

Correspondence Address: Nathan Chronister, 582 Laurelton Road, Rochester, NY, 14609, US

(21) Appl. No.: 11/147,044

(22) Filed: Jun. 7, 2005

Related U.S. Application Data
(60) Provisional application No. 60/577,882, filed on Jun. 8, 2004.

(51) Int. Cl. B64C 33/00

(52) U.S. Cl. 244/72

(57) ABSTRACT

The invention described here offers a more effective method of ornithopter flight control. To accomplish this, the ornithopter has dual microprocessor-controlled drive systems for flapping the wings independently of each other. Various wing movements can cause the ornithopter to turn, roll, or pitch up or down. Weight and complexity are reduced by eliminating the need for servo-controlled tail surfaces.

### CROSS-REFERENCE TO RELATED APPLICATIONS

This application claims the benefit of Provisional Patent Application Ser. No. 60/577,882, filed Jun. 8th, 2004 by the present inventor.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Invention

This invention pertains to the field of aeronautics and describes an aircraft sustained by beating wings (Class 244, Subclass 22).

2. Prior Art

Radio-controlled ornithopters, or flapping-wing aircraft, are becoming popular among radio-control hobby enthusiasts. Ornithopters are also being considered for use in aerial reconnaissance. In both roles, increased maneuverability is desirable. Ornithopters currently use a conventional rudder and elevator control system, or a moveable stabilizer that can be tilted left and right for steering and tilted up and down for pitch control.

U.S. Pat. No. 6,550,716 assigned to Neuros Co., Ltd., describes the control system commonly used in current radio controlled ornithopters. U.S. patent application No. 20020173217 by Andrew Sean Kinkade describes a similar system. In each case, the aircraft has a tail controlled by two hobby servos. At best, the maneuverability of the aircraft is similar to that of an airplane with rudder and elevator controls. Control becomes ineffective at low speeds as the ornithopter approaches hovering flight. This inability to hover limits the practical application of current ornithopter designs.

In both the Neuros and Kinkade designs, the radio receiver on board the ornithopter controls the two servos and also controls the speed of wing flapping. The wings cannot move independently of each other, nor is there any provision for systematically varying the wing speed at different points in the wingbeat cycle.

Ornithopter wing-flapping mechanisms are usually designed to flap the wings symmetrically. It is considered undesirable to have an imbalance of the right and left wings, which would interfere with the action of the tail or other control surfaces. For example, Eric Edward Tomas (U.S. Pat. No. 6,544,092) and Desmond Leigh-Hunt (U.S. Pat. No. 4,155,195) used a double crank to flap the wings in a symmetrical fashion. However, some degree of asymmetry is often allowed, in order to simplify the mechanism. U.S. Pat. No. 2,859,553 (P. H. Spencer), U.S. Pat. No. 3,626,555 (P. Albertini et al.), and U.S. Pat. No. 6,632,119 (Chernek, et al) show mechanisms that allow a degree of asymmetry. In these cases, however, the asymmetric flapping of the wings is not used for flight control.

In principle, flapping wings could generate large steering forces, resulting in a highly maneuverable and aerobatic aircraft. However, that potential has not been realizd in current designs.

### BRIEF SUMMARY OF THE INVENTION

The claimed invention is an ornithopter in which the wings can be controlled independently of each other, and their speed varied throughout the stroke, in order to control the flight of the aircraft and perform aerobatic maneuvers. Asymmetry of the wing flapping action is used to provide directional control. A microprocessor monitors the position of each wing and receives commands from a radio control receiver. The processor also controls two motors, which drive the left and right wings. This invention is intended to offer much greater maneuvering or steering forces than can be generated by a hinged tail assembly, thereby greatly increasing the maneuverability of the ornithopter and allowing it to maneuver effectively at lower speeds and when hovering.

### BRIEF DESCRIPTION OF THE SEVERAL VIEWS OF THE DRAWING

FIG. 1. Side view of ornithopter body. For clarity, the wings and ball-link connecting rods are not shown in this view.

FIG. 2. Front view of ornithopter body. For clarity, front spacers and components located behind the geartrain are not shown.

FIG. 3. Top view of the ornithopter, showing wings and tail. Internal and drive components are not shown in this view.

FIG. 4. Alternative wing-flapping mechanism with forward-facing gears.

FIG. 5. Alternative wing-flapping mechanism with slot flapping mechanism and push-rod for cyclical folding of wings as they flap.

### DETAILED DESCRIPTION OF THE INVENTION—PREFERRED EMBODIMENT

Typical ornithopter flight control systems include a radio receiver, an electronic speed control for the drive motor, and two servos. The servos control the flight path by moving a planar tail surface, or sometimes by moving an elevator and rudder like those used in radio controlled airplanes. This system provides a means of directional control, but the maneuverability of the ornithopter is limited.

In the invention described here, the wings rather than tail provide the maneuvering forces. This is achieved by using a separate motor and geartrain for each wing, controlled by a microprocessor. This allows the wings to move independently of each other, for steering, and it allows the wing flapping speed to vary systematically in different parts of the flapping cycle, in order to control the pitch of the aircraft. This system allows much greater maneuverability, particularly at low speeds where tail surfaces are not very effective. It also introduces new acrobatic features such as the ability to perform rolls, loops, and hovering flight. As an additional benefit, the weight and complexity are reduced, since there is no longer any need for servos to move the tail.

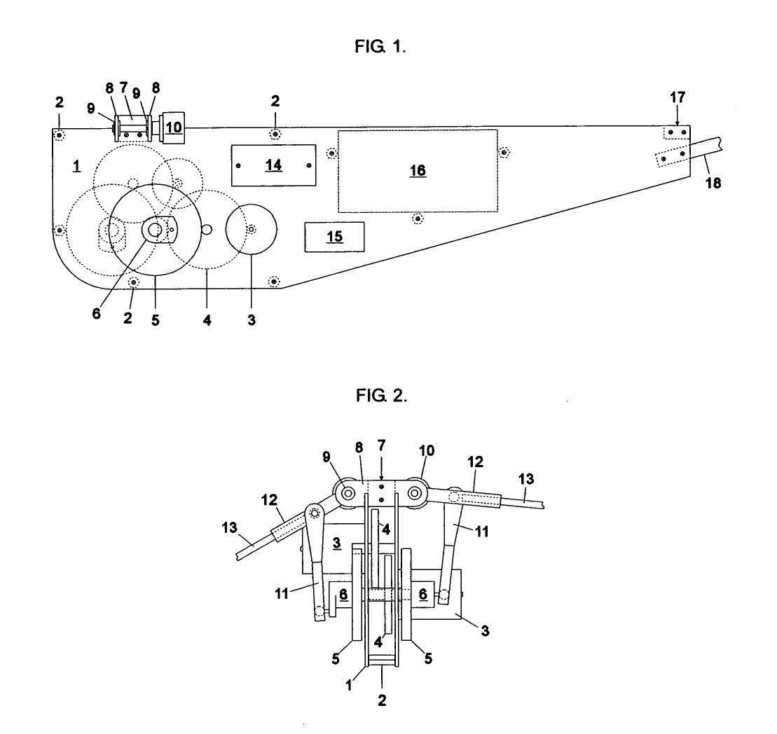

FIG. 1 is a side view of the ornithopter body. In the preferred method of construction, the ornithopter is constructed from two parallel fiberglass plates (1) held together by spacers (2). Independent drive systems exist on the left and right sides of the ornithopter. These consist of an electric motor (3) and reductive gears (4 and 5). The final gear (5) bears a crank piece (6), which drives the appropriate wing. A rectangular spacer (7) allows attachment of fiberglass plates (8) which hold bearings (9) for the wing hinge. A potentiometer (10) monitors the wing position, and the shaft of the potentiometer serves as the axle for the wing hinge. As shown in FIG. 2, ball-link connecting rods ( 11) connect the crank pieces (6) to their respective flapper bars (12), which can be made of machined aluminum. One connecting rod attaches to the front of its flapper bar. The other attaches to the rear of the flapper bar. In this way, it is possible for the drive gears (5) not to share the same axle. The wing spar (13) is a carbon rod inserted into a hole in the flapper bar.

The microprocessor (14) receives wing position information from the potentiometers and receives commands from the radio receiver (15). It also controls the motors using a standard pulse-width-modulated motor control output. A battery (16) provides power for the system.

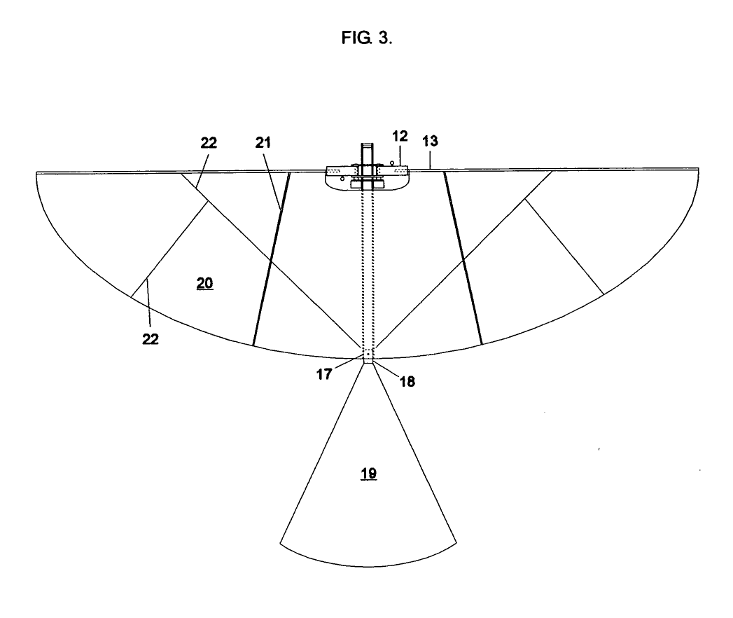

A rectangular spacer (17) provides a rear attachment point for the wing. Another spacer (18) forms the base of the tail. FIG. 3 shows the tail (19) and wings. The wings include the flapper bar (12) and leading edge spar (13) described earlier. To this is attached a fabric or plastic film membrane (20), which may be attached to the spar with adhesive or hemmed so that it slides onto the spar. A cambered rib (21) is affixed to the wing, using adhesive (for example, fabric tape). It can be made of bamboo, nylon, or other strong, flexible material. Additional battens (22) can be made of straight carbon rods and help prevent excessive flexing of the wing.

The microprocessor can be programmed to generate any desired wing motion. Some useful functions are as follows:

A) For straight flying, the left and right wings can be synchronized.

B) For turning left or right, one wing can travel slightly ahead of the other. The difference in timing causes a moderate steering force.

C) For roll control, one wing is given a rapid upstroke and slow downstroke, while the other wing is given a slow upstroke and rapid downstroke. This can be used for aerobatic maneuvers or for more aggressive turns.

D) Pitch control can be achieved by altering the ratio of upstroke and downstroke wing speeds, for both wings together. For example, placing emphasis on the upstroke will cause the ornithopter to pitch down, while placing emphasis on the downstroke will cause it to pitch up.

E) An alternative method of pitch control consists of increasing power in the upper or lower part of the flapping cycle.

F) To conserve energy and improve the efficiency of the flight, it is possible to increase wing speed from the start to the end of each stroke. Accelerating through the stroke uses less energy than maintaining full throttle at all times, yet due to unsteady flow effects it produces lift and thrust more efficiently.

G) Greater efficiency can be attained by optimizing the ratio of upstroke to downstroke wing speed.

H) For gliding flight, the wings can be stopped in a horizontal position. This position is maintained by the slight application of power to resist the force of lift on the wings.

I) For gliding flight, the ornithopter is steered by raising one wing and lowering the other. This causes the body to rotate about its long axis, thereby changing the position of the tail relative to the wings.

J) For gliding flight, pitch control is effected by raising or lowering both wings. With the wings lowered, the ornithopter will pitch up and glide more slowly, whereas with the wings raised, the ornithopter will enter a dive.

### DETAILED DESCRIPTION OF THE INVENTION—ALTERNATIVE EMBODIMENTS

Electronic means for controlling the ornithopter wings may vary. For example, it is possible to combine the radio receiver and microcontroller onto a single circuit board. Also, it would be possible to substitute optical encoders or other sensors to detect the positions of the two wings. A sensor could be installed on the gear shaft or motor instead of at the wing hinge for this purpose.

A gyroscope or accelerometer could be used in order to help stabilize the ornithopter. This could improve its ability to hover and perform other maneuvers. Typical gyroscopes used with hobby radio control systems alter the signal going from the receiver to one of the servos in response to motion of the aircraft on a particular axis. In the present invention, the gyroscope would modify the radio control signal going to the microcontroller.

A large variety of wing-flapping mechanisms has been used or proposed for ornithopter use. Many of these mechanisms can be adapted to flap two wings independently. Therefore the subject of this invention is regarded not as a particular mechanism for driving two wings independently, but rather the use of such for ornithopter flight control.

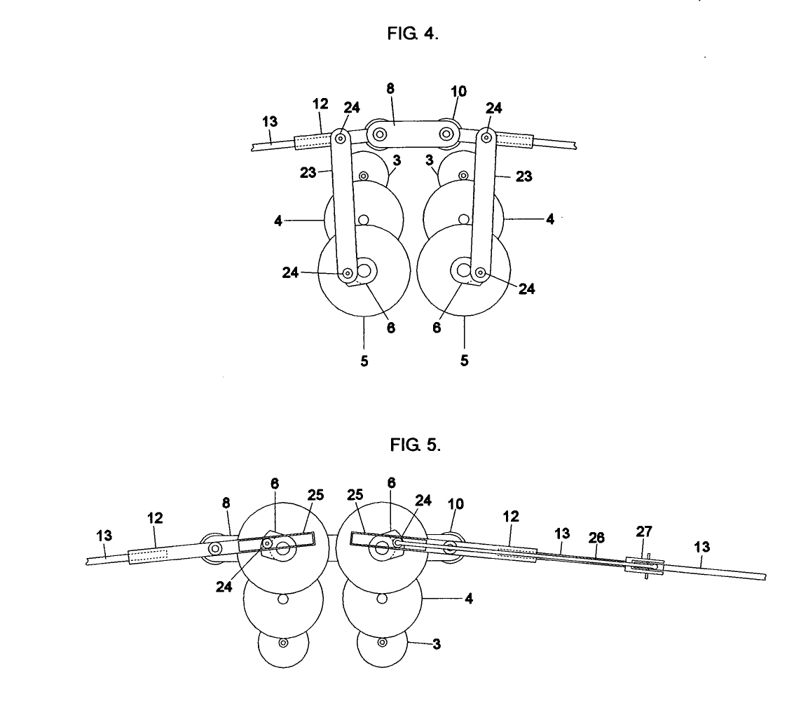

One alternative wing-flapping mechanism is shown in FIG. 4. This mechanism differs from the preferred embodiment in that the gear shafts in the gearbox are oriented approximately parallel to the long axis of the ornithopter fuselage, instead of perpendicular to that axis. This system allows the use of connecting rods (23) that operate in the same plane as the wing flapping and therefore may incorporate ball bearings (24). This may reduce friction compared with the ball link connecting rods (11) of the preferred embodiment. The ornithopter may be more complicated to construct in this alternative embodiment.

A second alternative wing-flapping mechanism would use a slotted wing lever, as shown in FIG. 5. The crank piece (6) has a ball bearing (24) that travels in a slot in the wing lever (25), causing the wing to move up and down cyclically. The ball bearing rolls along the inside surface of the slot without rubbing. Such use of a ball bearing will decrease friction, though the mechanism would also operate without a ball bearing.

In addition to the slotted wing lever mechanism of FIG. 5, a push-rod (26) may connect the crank piece (6) to a hinge (27) in the wing spar (13). This arrangement causes the wing to cyclically fold or bend during flight, so that the upstroke of the flapping wing may be executed with decreased air resistance. In FIG. 5, the hinge (27) is illustrated as moving in the plane of the wing (fore and aft). Alternatively, the hinge could move up and down, or at some oblique angle. The timing of the hinge action could be adjusted by using a second crank piece on the same output shaft as crank piece (6), or on a separate shaft. By doing so, the phasing of the two crank pieces could be adjusted to achieve any desired phase relationship or timing between the flapping motion and the hinge action.

Although the preferred embodiment is a radio controlled ornithopter, the method of using independently moveable wings for flight control is also applicable to autonomous or manned ornithopters. In either case, the microcontroller would still coordinate the flapping of the wings in order to produce the desired control effect. For an autonomous ornithopter, the microcontroller would determine which control maneuvers to execute, or would receive instructions from another device on board the ornithopter. In the case of a manned ornithopter, the microcontroller would coordinate the wings in order to carry out control inputs from a human pilot on board the ornithopter.

1. A method for controlling the flight of an ornithopter, comprising the steps of:
a providing a microcontroller with dual motor control outputs
b. providing dual motors and means to drive the left and right wings of said ornithopter independently
b. providing control signals to said microcontroller
c. providing data from wing position sensors to said microcontroller
d. using said microcontroller to synchronize said left and right wings of said ornithopter
e. using said microcontroller to exercise independent control of said left and right wings to control the flight of said ornithopter
whereby the flight of said ornithopter is controlled without use of control surfaces such as a rudder.

2. An ornithopter, wherein the improvement comprises:
a. independently moveable left and right wings
b. means for coordinating the motion of said wings,
whereby the action of said wings may produce steering forces,
whereby the flight direction of said ornithopter may be controlled without use of control surfaces such as a rudder.

3. The ornithopter of claim 2, wherein said means for coordinating the motion of said wings comprises:
a. a microcontroller
b. sensors for detecting the positions of said wings
c. dual motor control circuits controlled by said microcontroller.

4. An ornithopter, having wings, wherein the improvement comprises:
a. a lever for flapping said wings
b. a slot in said lever
c. a crank pin, which resides in said slot, such that the rotation of said crank pin causes said wings to flap
d. a hinge in said wings, allowing said wings to fold
e. a pushrod, connecting said crank pin with said hinge, such that the rotation of said crank pin causes said wings to fold and unfold cyclically.
